(19) United States
(12) Patent Application Publication
(10) Pub. No.: US 2007/0174217 A1
(43) Pub. Date: Jul. 26, 2007

(54) METHOD OF PAYING FOR POSTAGE AMOUNTS VIA A TELECOMMUNICATIONS NETWORK

(75) Inventor: Fabien Chatte, Nogent Sur Marne (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST Technologies, Bagneux (FR)

(21) Appl. No.: 11/625,540

(22) Filed: Jan. 22, 2007

(30) Foreign Application Priority Data
Jan. 23, 2006 (FR) 0650229

(51) Int. Cl. G06F 17/00

(52) U.S. Cl. 705/410

(57) ABSTRACT

A method of paying for a postage amount relating to franking a mail item addressed to a sendee by a sender, said method comprising the following operations:
inputting the address of the sendee or “destination address” borne on the mail item into a handheld communications device of the sender;
inputting a postage amount into the handheld communications device;
generating a franking authorization code in the handheld communications device;
sending said franking authorization code to a server for issuing franking authorizations;
debiting the account of the sender for an amount corresponding to the postage amount of the requested franking, and having the server for issuing franking authorizations send said franking authorization code;
displaying said franking authorization code on the handheld communications device;
having the franking authorization code copied by the sender onto the mail item; and
depositing the mail item in a mailbox.

### TECHNICAL FIELD

The present invention relates to the field of mail handling, and it relates more particularly to a method of paying for postage amounts via a telecommunications network.

### STATE OF THE ART

Today, when a private individual or a very small business does not have a postage meter or “franking machine” and wishes to frank mail, it is necessary, optionally after weighing, to stick a stamp on each envelope or parcel to be sent before depositing it in a public mailbox. However, if the person entrusted with that operation does not have any stamps available, said person must go to the nearest office of the postal administration so as to buy stamps or so as to have a franking mark representing a postage amount affixed to the envelop or parcel. Unfortunately, that is possible only if said office is open to the public at that time.

That is why, there exists today an unsatisfied need for a method of paying for postage amounts that avoids the above-described drawbacks, and in particular that can be accessible by anyone 24 hours per day, 365 hours per year, and that is particularly simple to implement.

### DISCLOSURE OF THE INVENTION

The present invention thus provides a novel method of paying for a postage amount relating to franking a mail item addressed to a sendee by a sender, said method comprising the following operations:

inputting the address of the sendee or “destination address” borne on the mail item into a handheld communications device of the sender;

inputting a postage amount into the handheld communications device;

generating a franking authorization code in the handheld communications device;

sending said franking authorization code to a server for issuing franking authorizations;

debiting the account of the sender for an amount corresponding to the postage amount of the requested franking, and having the server for issuing franking authorizations send said franking authorization code;

displaying said franking authorization code on the handheld communications device;

having the franking authorization code copied by the sender onto the mail item; and

depositing the mail item in a mailbox.

Thus, the use of an ordinary mobile telephone makes it possible, at any time, and therefore independently of post office opening hours, to pay automatically for any postage amount for franking purposes.

Depending on the implementation, the operation of inputting said destination address may comprise either manually inputting it on the keypad of the handheld communications device, or having it captured digitally by said handheld communications device. Such manual inputting or such digital capturing may be limited to manually inputting or digitally capturing the destination post code.

Advantageously, the operation of generating the franking authorization code is performed on the basis of a combination of items of data taken at least from the following items of data: postage amount of the franking, destination address, or destination post code.

Preferably, the operation of sending the franking authorization code to the server for issuing franking authorizations from the handheld communications device comprises sending a request including said franking authorization code. Said request may include a digital signature of the sender and may be sent via a short message.

Advantageously, the operation of debiting the account of the sender includes verifying that sufficient credit exists in the account of the sender with the server for issuing franking authorizations or verifying that the sender has sufficient telephone credit with a server of the telephone operator of the sender.

Preferably, the operation of sending the franking authorization code to the handheld communications device of the sender from the server for issuing franking authorizations comprises sending a request including said franking authorization code. This type of request may be sent via a short message of the Short Message Service (SMS) type.

The invention also provides a handheld communications device serving to implement the above mentioned method of paying for a postage amount and constituted by any one of the following devices: a cellular telephone, a communicating personal digital assistant, and a communicating laptop computer. The device may be further provided with a communicating light pen for digitally capturing the destination address.

The invention also relates to a computer program including code instructions for performing the steps of the above-mentioned method of paying for a postage amount, when said method is executed on the handheld communications device.

### BRIEF DESCRIPTION OF THE DRAWINGS

Other characteristics and advantages of the invention appear more clearly from the following description given by way of non-limiting indication, and with reference to the accompanying drawings, in which:

FIG. 1 shows an example of a network architecture making it possible to implement the method of invention for paying for postage amounts; and

FIG. 2 is a flow chart explaining the various steps of the method implemented in the network of FIG. 1.

### IMPLEMENTATION(S) AND EMBODIMENT(S) OF THE INVENTION

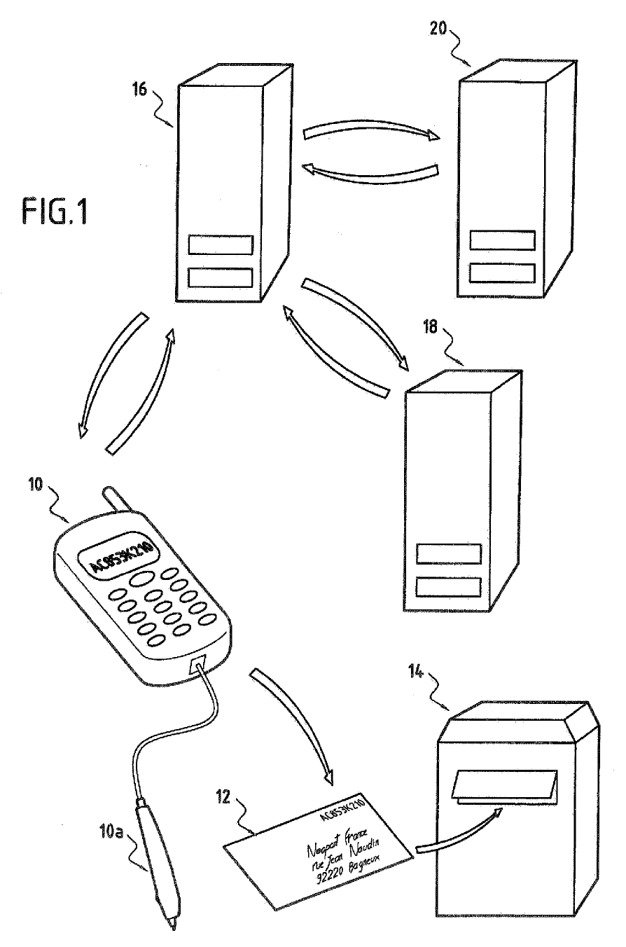

FIG. 1 shows an example of network architecture that is necessary for implementing the method of the invention for paying for postage amounts. It is based on the use of a handheld communications device 10 which is used to pay for a postage amount relating to franking a mail item 12 sent to a sendee and whose sender wishes to have it sent by depositing it in any public mailbox 14 of the postal administration. The term “mail item” is used to mean not only an envelope but also a label serving to is be stuck to a thick envelope, or any parcel to be sent.

During the process of paying for a postage amount, the handheld communications device of the sender is put into communication with a server system 16 for issuing franking authorizations, which server can itself be put into communication with a server system 18 of the postal administration, and optionally with a server system 20 of a telephone operator for the purpose of paying for the postage amount of the requested franking by debiting the telephone account of the sender, when that payment has not been made previously by the server system 16 with which the sender holder of the handheld communications device can also have an account.

The handheld communications device 10 can be constituted by any data-processing device making it possible to set up long-distance wireless communications via a terrestrial or satellite wireless telecommunications network (such as a network of one of the following types: Global Service for Mobile Communications (GSM), Universal Mobile Telecommunications System (UMTS), Worldwide Interoperability of Microwave Access (WiMax), etc.), such as a cellular telephone or “cellphone”, a communicating Personal Digital Assistant (PDA), or indeed a communicating laptop computer. In a preferred embodiment, said handheld communications device can include a digital capture device 10A such as a digital camera or a light pen.

The server system 16 disposed on the site of the provider of the franking authorizations incorporates one or more computer central processing units containing one or more databases and it is controlled and managed conventionally by one or more computer terminals (not shown). The server system 18 of the postal administration has a similar structure with one or more databases, in particular a database of authorization codes. Similarly, the server system 20 of the telephone operator has a similar structure with one or more databases, in particular a customer database including accounting data relating to the customers of said operator.

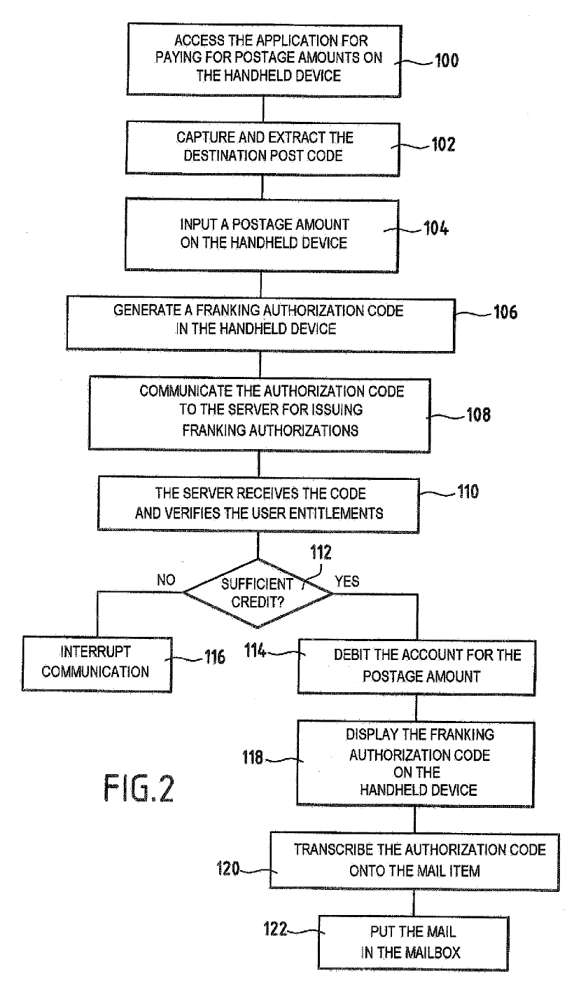

FIG. 2 is a flow chart showing the various steps of a method making it possible for a postage amount to be paid for by a sender of a mail item by means of his or her handheld communications device.

In a first step 100 of an implementation of the method, the sender who wishes to send a mail item 12 clicks on an icon corresponding to a postage payment application that is pre-installed on the handheld communications device. This validation automatically activates the digital capture function of the device that enables the sender, by means of the digital capture device 10A associated with or integrated in the handheld communications device, to input, in a step 102, an image of the destination address previously put by the sender on the mail item, validation of the input of said image by acting on an image-taking button (not shown) of the handheld communications device causing the characters of the input address, or optionally merely of the destination post code extracted from said address, to be recognized automatically. When the capture device is a communicating light pen (e.g. a Bluetooth pen), such intelligent character recognition is performed as the address is being written by the sender.

However, it should be noted that, when the handheld communications device does not have a light capture device, the sender is asked to input the destination address manually or to choose the geographical zone of the destination of the mail item, from among a set of proposed zones, e.g. via a scroll-through menu.

The handheld communications device can then, in a next step 104, via its display screen, request the sender to indicate the postage amount with which the sender wishes to frank the mail item for the purpose of sending it. The postage amount, which is a function of the services required (priority or economy, for example), of the geographical zone of destination (national or foreign) and optionally of the class of weight of the mail sent, is left entirely up to the responsibility of the sender who thus needs to have at his or her disposal the various postage rates applicable at the date of sending. By way of example, for sending a letter of under 20 grams priority-rate from France to the United States, the sender has to pay 0.930 euros, whereas for sending a parcel of 8 kg economy-rate from France to a French overseas Département, the sender has to pay 14 euros.

Then, in a step 106, the handheld communications device generates a franking authorization code on the basis of a concatenated combination of information input previously by the sender such as the destination address, in particular the destination geographical zone, and the postage amount, and other information at his or her disposal such as (without the following list being exhaustive) date, time, version of the application software, identifier of the Subscriber Identity Module (SIM) card, etc. Said code can, advantageously be enciphered.

The handheld communications device then, in a step 108, sends to the server 16 for issuing franking authorizations a request in the form of a short message of the SMS type containing the previously generated franking authorization code.

In a further step 110, the server 16 receives the request and, on the basis of the telephone number of the handheld communications device (obtained conventionally on the basis of the International Mobile Subscriber Identity (IMSI) number or of the International Mobile Equipment Identity (IMEI) number of the handheld communications device, which numbers are transmitted during the call), makes various verifications depending on whether or not the holder of the handheld communications device (the sender) is a customer of the franking authorization provider. If the sender is a customer of that provider (the sender thus has an account with the provider), the server 16 then verifies the sender's entitlements and, if the sender's account has sufficient credit (answer “yes” to the test in step 112), debits, in step 114, the sender's customer account for the amount corresponding to the requested franking. If the credit is insufficient, the server asks the sender to recharge his or her account with credit, and the communication is then interrupted (step 116). The sender cannot then send the mail item unless the sendee is left to pay for the postage amount plus a fine on delivery of the mail item.

If the sender is not a customer of the franking authorization provider and thus does not have a customer account with the server 16, said server forwards the postage amount to be paid and the telephone number of the handheld communications device that is associated with the sender to the server of the telephone operator 20 who can, in turn, verify, by accessing its own customer database, whether the sender has sufficient telephone credit for paying for the postage amount of the requested franking. If the telephone operator deems that the credit of the sender is insufficient, said operator so informs the authorization provider who then asks the sender, as described above, to recharge his or her account with credit, and the communication is then interrupted (step 116). Conversely, if said credit is sufficient, the sender's account is debited for the corresponding amount and the server 16 is informed so that, in step 118, the server 16 can respond to the franking authorization code being communicated by generating a request addressed to the handheld communications device, preferably in the form of a short message of the SMS type containing a franking authorization, this request causing the franking authorization code to be displayed on the handheld communications device.

The sender then, in a step 120, merely has to transcribe the franking authorization code onto the mail item and, without any other formality, merely has to deposit the mail item in the mailbox 14 in a final step 122.

At the end of every day, and preferably a few minutes before midnight, the server 16 for issuing franking authorizations transfers to the server of the postal administration 18 all of the data (franking authorization codes and associated postage amounts) relating to the payment operations made during the day or, more simply, gives the server of the postal administration direct access rights to all of its data.

Thus, with the present invention, it is very simple for any sender to send any mail item (envelope or parcel) to any destination without having to go to an office of the postal administration, the received franking authorization code (which replaces and acts as the stamp or the postal imprint of a postage meter although said code has no monetary value) borne by each mail item being sufficient for the postal administration to check said item.

When the mail item is deposited at one of its collection offices, the postal administration firstly optically reads the mail item for the purpose of extracting therefrom the franking authorization code and the destination address, and more precisely the destination geographical zone (destination post code) of the mail item, and optionally the service when said service is pre-printed on the mail item, e.g. “priority” service, and secondly, if necessary, weighs said mail item so as to determine the class of weight of it, and, on the basis of this information, the postal administration calculates the amount of postage necessary is for said mail item. It is then merely necessary for the postal administration to verify that the amount paid by the sender and associated with the authorization code in the server is at least equal to the calculated postage amount in order to authorize it to be delivered to its destination. In the event that the payment is insufficient, the postal administration calculates the payment surcharge that must be paid by the sendee in order to receive the mail item.

It should also be noted that, in addition to making it possible to avoid any manual input error, the use of a communicating light pen also makes it possible to increase the security of the system. It is then possible to ask the user to terminate the input procedure with a signature and to attach that signature with the request to the authorizations server, preferably in the form of a message of the Multimedia Messaging Service (MMS) type. Comparing the digital signature sent with the digital signature stored at said server provides an additional level of security.

What is claimed is:

1. A method of paying for a postage amount relating to franking a mail item addressed to a sendee by a sender, said method comprising the following operations:
inputting the address of the sendee or “destination address” borne on the mail item into a handheld communications device of the sender;
inputting a postage amount into the handheld communications device;
generating a franking authorization code in the handheld communications device;
sending said franking authorization code to a server for issuing franking authorizations;
debiting the account of the sender for an amount corresponding to the postage amount of the requested franking, and having the server for issuing franking authorizations send said franking authorization code;
displaying said franking authorization code on the handheld communications device;
having the franking authorization code copied by the sender onto the mail item; and
depositing the mail item in a mailbox.

2. A method according to claim 1, wherein the operation of inputting said destination address comprises manually inputting it on the keypad of the handheld communications device.

3. A method according to claim 1, wherein the operation of inputting said destination address comprises having a destination post code captured digitally by said handheld communications device.

4. A method according to claim 2, wherein said manual input or digital capture of said destination address is limited to manually inputting or digitally capturing the destination post code.

5. A method according to claim 1, wherein the operation of generating the franking authorization code is performed on the basis of a combination of items of data taken at least from the following items of data: postage amount of the franking, destination address, or destination post code.

6. A method according to claim 1 wherein the operation of sending the franking authorization code to the server for issuing franking authorizations from the handheld communications device comprises sending a request including said franking authorization code.

7. A method according to claim 6, wherein said request includes a digital signature of the sender.

8. A method according to claim 1, wherein the operation of debiting the account of the sender includes verifying that sufficient credit exists in the account of the sender with the server for issuing franking authorizations or verifying that the sender has sufficient telephone credit with a server of the telephone operator of the sender.

9. A method according to claim 1, wherein the operation of sending the franking authorization code to the handheld communications device of the sender from the server for issuing franking authorizations comprises sending a request including said franking authorization code.

10. A handheld communications device serving to implement the method of paying for a postage amount according to claim 1.

11. A device according to claim 10, said device being constituted by any one of the following devices: a cellular telephone, a communicating personal digital assistant, and a communicating laptop computer.

12. A device according to claim 11, said device being further provided with a communicating light pen for digitally capturing the destination address.

13. A computer program including code instructions for performing the steps of the method of paying for a postage amount according to claim 1, when said method is executed on the handheld communications device.
